(19) United States
(12) Patent Application Publication
(10) Pub. No.: US 2026/0361087 A1
(43) Pub. Date: Nov. 12, 2026

(54) ENERGY STORAGE APPARATUS, OUTPUT CONTROL METHOD AND DEVICE

(71) Applicant: SHENZHEN HELLO TECH ENERGY CO., LTD, Shenzhen (CN)

(72) Inventors: Qingbin LIN, Shenzhen (CN); Gaosong SHEN, Shenzhen (CN); Feiyan LUO, Shenzhen (CN); Hongliang ZHAO, Shenzhen (CN); Dong HAN, Shenzhen (CN); Wenhai LIN, Shenzhen (CN)

(21) Appl. No.: 19/726,893

(22) Filed: Jun. 30, 2026

(30) Foreign Application Priority Data
Dec. 19, 2025 (CN) 202511945349.7

(51) Int. Cl. H02J 3/32; H02M 1/36

(52) U.S. Cl. CPC H02J 3/32; H02M 1/36

(57) ABSTRACT

An energy storage apparatus, an output control method, and a device are provided. The energy storage apparatus includes an AC input interface configured to receive an external AC power supply, an AC output interface configured to output alternating current externally, an energy storage battery configured to store and output electric energy, and an AC-DC conversion circuit. The energy storage apparatus has a first operating mode and a second operating mode when the AC power supply is disconnected. In the first operating mode, the AC-DC conversion circuit is configured to start immediately, receive and convert the electric energy of the energy storage battery, and supply power to the AC output interface; and in the second operating mode, the AC-DC conversion circuit is configured to start subsequent to a predetermined delay duration, receive and convert the electric energy of the energy storage battery, and supply power to the AC output interface.

### CROSS-REFERENCE TO RELATED APPLICATIONS

This application claims a priority to Chinese patent application No. 202511945349.7, filed on Dec. 19, 2025, the entire contents of which are incorporated herein by reference.

### FIELD

The present disclosure relates to the field of energy storage technologies, and more particularly, to an energy storage apparatus, an output control method, and a device.

### BACKGROUND

An energy storage apparatus can store electric energy when utility power is normal, and supply power to a household load during a power outage, to ensure basic power consumption demands of households. However, the existing apparatus generally restores power supply to all connected loads immediately after the power outage. For a load with an automatic heat preservation function such as a refrigerator, such immediate power supply is unnecessary. Such immediate power supply instead causes premature consumption of energy storage electric charge and weakens continuous power supply capacity during the power outage. Further, the existing energy storage apparatus adopts a relatively single output control mode and lacks flexible strategies adjustable in accordance with different power consumption scenarios.

### SUMMARY

Embodiments of the present disclosure provide an energy storage apparatus, an output control method, an output control device, and a non-volatile computer-readable storage medium.

In the embodiments of the present disclosure, the energy storage apparatus includes: an alternating-current (AC) input interface configured to receive an external AC power supply; an AC output interface connected to the AC input interface and configured to output alternating current externally; an energy storage battery configured to store and output electric energy; and an AC-direct current (DC) conversion circuit having an end connected to the energy storage battery and the other end connected to the AC output interface. The energy storage apparatus has a first operating mode and a second operating mode when the AC power supply is disconnected. In the first operating mode, the AC-DC conversion circuit is configured to start immediately, receive and convert the electric energy of the energy storage battery, and supply power to the AC output interface; and in the second operating mode, the AC-DC conversion circuit is configured to start subsequent to a predetermined delay duration, receive and convert the electric energy of the energy storage battery, and supply power to the AC output interface.

In some embodiments, the energy storage apparatus further includes an AC input branch. The AC input interface is connected to the AC-DC conversion circuit and the AC output interface via the AC input branch. The AC input branch includes a first switching unit configured to control connection and disconnection of the AC input branch. The first switching unit is turned off when the AC power supply is disconnected.

In some embodiments, the energy storage apparatus further includes a control circuit. The control circuit is configured to, when the energy storage apparatus is in the second operating mode and the AC power supply is disconnected, initiate timing, and control the AC-DC conversion circuit to start upon expiration of the predetermined delay duration.

In some embodiments, when the timing of the control circuit has not ended and the AC power supply is connected, the AC power supply is configured to supply power to the AC output interface via the AC input interface.

In some embodiments, when the AC power supply is disconnected and the AC-DC conversion circuit is operating, upon the AC-DC conversion circuit receiving an instruction to enter the second operating mode, the AC-DC conversion circuit stops operating and starts upon expiration of the predetermined delay duration.

In some embodiments, the AC power supply is configured to, when the predetermined delay duration has not expired and the AC power supply is connected, supply power to the AC output interface via the AC input interface.

In some embodiments, the AC power supply is configured to, when the energy storage apparatus is in the first operating mode or the second operating mode and the AC power supply is connected, supply power to the AC output interface via the AC input interface.

In some embodiments, after the energy storage apparatus restarts, and when AC power supply is disconnected, the AC-DC conversion circuit operates in the first operating mode by default.

In some embodiments, the energy storage apparatus further includes a second switching unit. The second switching unit is connected between the AC-DC conversion circuit and the AC output interface, and is configured to control connection and disconnection between the AC-DC conversion circuit and the AC output interface. When the energy storage apparatus is in the second operating mode, timing is initiated, and the second switching unit is controlled to turn on upon expiration of the predetermined delay duration, to connect the AC-DC conversion circuit to the AC output interface.

An output control method in the embodiments of the present disclosure is used for the energy storage apparatus. The energy storage apparatus includes an energy storage battery and an AC-DC conversion circuit. The output control method includes: monitoring a state of an external AC power supply; determining an operating mode of the energy storage apparatus in response to monitoring that the external AC power supply is disconnected; in response to determining that the operating mode of the energy storage apparatus is a first operating mode, controlling the AC-DC conversion circuit to start immediately, receive and convert electric energy of the energy storage battery, and supply power to a load; or in response to determining that the operating mode of the energy storage apparatus is a second operating mode, controlling the AC-DC conversion circuit to start subsequent to a predetermined delay duration, receive and convert the electric energy of the energy storage battery, and supply power to the load.

In some embodiments, the energy storage apparatus further includes an AC input branch. The output control method further includes: disconnecting the AC input branch in response to monitoring that the external AC power supply is disconnected.

In some embodiments, the energy storage apparatus further includes a first switching unit arranged in the AC input branch and a second switching unit connected to an output end of the AC-DC conversion circuit. Said controlling the AC-DC conversion circuit to start immediately includes: controlling the first switching unit to turn off to disconnect the AC input branch.

In some embodiments, said in response to determining that the operating mode of the energy storage apparatus is the second operating mode, controlling the AC-DC conversion circuit to start subsequent to the predetermined delay duration includes: generating a start instruction to enable the AC-DC conversion circuit to perform an AC-DC conversion operation upon expiration of the predetermined delay duration.

In some embodiments, said controlling the AC-DC conversion circuit to start subsequent to the predetermined delay duration includes: when the predetermined delay duration has not expired and the external AC power supply is connected, controlling the external AC power supply to supply power to the AC output interface via the AC input interface.

In some embodiments, the output control method further includes: when the external AC power supply is disconnected and the AC-DC conversion circuit is operating, upon the AC-DC conversion circuit receiving an instruction to enter the second operating mode, controlling the AC-DC conversion circuit to stop operating and start upon expiration of the predetermined delay duration. Said controlling the AC-DC conversion circuit to stop operating and start upon expiration of the predetermined delay duration includes: when the predetermined delay duration has not expired and the AC power supply is connected, controlling the AC power supply to supply power to the AC output interface via the AC input interface.

In some embodiments, the output control method further includes: after the energy storage apparatus restarts, and when AC power supply is disconnected, controlling the AC-DC conversion circuit to operate in the first operating mode by default.

In some embodiments, the energy storage apparatus further includes a second switching unit connected to an output end of the AC-DC conversion circuit. Said in response to determining that the operating mode of the energy storage apparatus is the second operating mode, controlling the AC-DC conversion circuit to start subsequent to the predetermined delay duration includes: controlling the AC-DC conversion circuit to operate immediately when the external AC power supply is disconnected, and turning on the second switching unit upon expiration of the predetermined delay duration, to output electric energy to the load.

In some embodiments, the output control method further includes: in response to receiving a delay duration adjustment instruction, adjusting the predetermined delay duration based on the delay duration adjustment instruction.

In some embodiments, the output control method further includes: in response to receiving a countdown end instruction or monitoring that the external AC power supply is restored, setting the predetermined delay duration to zero.

In some embodiments, the output control method further includes: in response to monitoring that the external AC power supply is restored, controlling the AC input branch to close, to enable the external AC power supply to supply power to the load.

The output control device in the embodiments of the present disclosure is used for the energy storage apparatus. The energy storage apparatus includes: a monitoring module configured to monitor a state of an external AC power supply; a determining module configured to determine an operating mode of the energy storage apparatus in response to monitoring that the external AC power supply is disconnected; and a control module configured to control the AC-DC conversion circuit in the energy storage apparatus to start immediately in response to determining that the operating mode of the energy storage apparatus is a first operating mode, to convert electric energy of the energy storage battery into alternating current and supply power to a load; or control the AC-DC conversion circuit to start subsequent to a predetermined delay duration in response to determining that the operating mode of the energy storage apparatus is a second operating mode, to convert the electric energy of the energy storage battery into the alternating current and supply power to the load.

The energy storage apparatus in the embodiments of the present disclosure includes a processor and a memory. The memory has a computer program stored thereon. The computer program, when executed by the processor, causes the processor to implement the output control method.

The non-volatile computer-readable storage medium in the embodiments of the present disclosure includes a computer program. The computer program, when executed by a processor, causes the processor to implement the output control method.

In the output control method, the energy storage apparatus, and the storage medium according to the embodiments of the present disclosure, by differentially controlling the power supply to the load based on the set operating mode after the utility power is disconnected, immediate power supply to non-urgent loads such as refrigerators can be effectively avoided, reducing unnecessary consumption of energy storage electric charge, and significantly improving endurance of the energy storage apparatus during a power outage. Also, the method provides a selectable strategy of the first operating mode and the second operating mode, allowing a user to flexibly choose based on actual power consumption scenarios and needs, enhancing personalization and intelligence level of apparatus use.

### BRIEF DESCRIPTION OF THE DRAWINGS

The above and/or additional aspects and advantages of the present disclosure will become more apparent and more understandable from the following description of embodiments taken in conjunction with the accompanying drawings.

FIG. 1 is a module schematic diagram of an energy storage apparatus when powered through an AC input branch according to some embodiments of the present disclosure.

FIG. 2 is a module schematic diagram of an energy storage apparatus when powered through an AC-DC conversion circuit according to some embodiments of the present disclosure.

FIG. 3 is a schematic flowchart of an output control method for an energy storage apparatus according to some embodiments of the present disclosure.

FIG. 4 is a module schematic diagram of an output control device of an energy storage apparatus according to some embodiments of the present disclosure.

FIG. 5 to FIG. 15 are schematic flowcharts of an output control method for an energy storage apparatus according to some embodiments of the present disclosure.

### DETAILED DESCRIPTION OF THE EMBODIMENTS

Embodiments of the present disclosure will be described in detail below. The examples of embodiments are as illustrated in the accompanying drawings, throughout which same or similar elements, or elements having same or similar functions, are denoted by same or similar reference numerals. The embodiments described below with reference to the drawings are illustrative only, and are intended to explain, rather than limit, the present disclosure.

The present disclosure provides an energy storage apparatus. The energy storage apparatus may be an energy storage apparatus mounted in household scenarios, which generally takes a battery as a core and is equipped with a photovoltaic module, an inverter, a controller, and other components. The energy storage apparatus can be charged during grid off-peak price periods or generate electric energy from renewable energy sources such as solar power for storage, and discharge the electric energy for household electrical appliances during peak power consumption hours, power outages, or high-price periods. The energy storage apparatus has functions including peak shaving and valley filling, enhancing power usage autonomy, reducing electricity expenses, supplying power to the grid for revenue, and providing backup power in emergencies. Also, monitoring and regulation of electric charge is achieved, providing a safe, economical, and flexible energy solution for household power consumption.

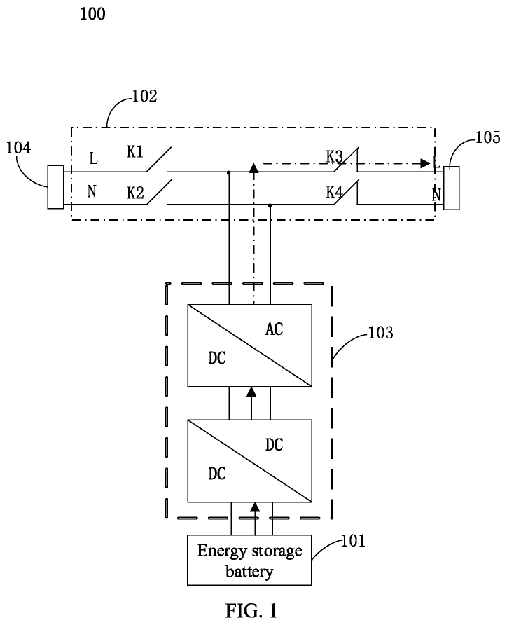

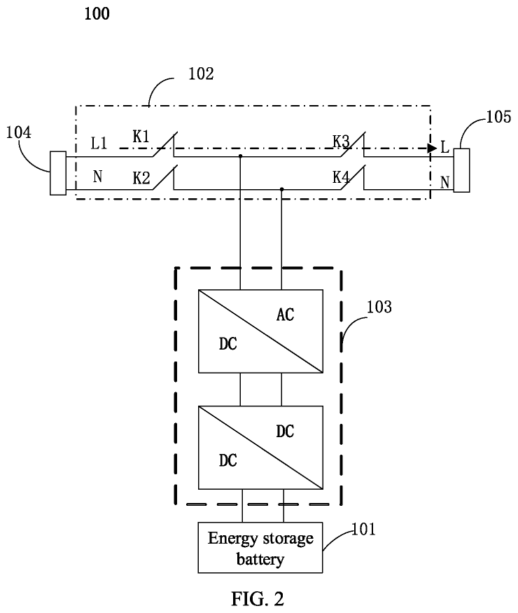

As illustrated in FIG. 1 or FIG. 2, the energy storage apparatus 100 includes an energy storage battery 101, an AC input branch 102, an AC-DC conversion circuit 103, an AC input interface 104, an AC output interface 105, and a control circuit.

The energy storage battery 101 is an energy storage core of the energy storage apparatus 100, and is configured to store and output direct-current electric energy. The energy storage battery 101 may adopt a high energy density battery such as a lithium-ion battery, a lithium iron phosphate battery, etc. The AC input interface 104 is configured to receive an external AC power supply (e.g., utility power). The AC output interface 105 is configured to output alternating current externally, to supply power to a connected load.

The AC-DC conversion circuit 103 (e.g., an inverter) is connected between the energy storage battery 101 and the AC output interface 105, and is configured to convert direct current output by the energy storage battery 101 into alternating current. When the external AC power supply is disconnected, the energy storage apparatus 100 has a configurable first operating mode and a configurable second operating mode. In the first operating mode, the AC-DC conversion circuit 103 is configured to start immediately to convert electric energy of the energy storage battery 101 and supply power to the AC output interface 105, achieving an uninterruptible power supply (UPS) function. In the second operating mode, the AC-DC conversion circuit 103 is configured to start subsequent to a predetermined delay duration to delay power supply to the load, thus saving energy storage electric charge and extending endurance. Also, for a special load such as a compressor (e.g., refrigerator and air conditioner), a high-low pressure difference of a system has not yet been balanced after a power outage. If forced to restart within a short period, the compressor is highly likely to suffer locked rotor or damage, which will greatly shorten a service life of a product.

The AC input branch 102 is connected between the AC input interface 104 and the AC output interface 105, and is configured to form a power supply path when the external AC power supply is normal. A first switching unit (such as a first switch K1 and a second switch K2 in the figure) is arranged in the AC input branch 102, and is configured to control connection and disconnection of the branch. When the external AC power supply is disconnected, the first switching unit is controlled to turn off, to achieve safe isolation between the load and a power grid.

The control circuit (which may be integrated into a processor of the energy storage apparatus 100 or provided as an independent module) is configured to execute the output control logic of the present disclosure. When the energy storage apparatus 100 is in the second operating mode and the external AC power supply is disconnected, the control circuit is configured to initiate timing, and to output a control signal to perform a corresponding operation upon expiration of the predetermined delay duration. When the timing of the control circuit has not ended and the AC power supply is connected, the AC power supply is configured to supply power to the AC output interface 105 via the AC input interface 104.

When the AC power supply is disconnected and the AC-DC conversion circuit 103 is operating, upon the AC-DC conversion circuit 103 receiving an instruction to enter the second operating mode, the AC-DC conversion circuit 103 stops operating and starts upon expiration of the predetermined delay duration. When the predetermined delay duration has not expired and the AC power supply is connected, the AC power supply is configured to supply power to the AC output interface 105 via the AC input interface 104.

When the energy storage apparatus 100 is in the first operating mode or the second operating mode and the AC power supply is connected, the AC power supply is configured to supply power to the AC output interface 105 via the AC input interface 104.

After the energy storage apparatus 100 restarts, and when the AC power supply is disconnected, the AC-DC conversion circuit 103 operates in the first operating mode by default.

Further, the energy storage apparatus 100 further includes a second switching unit (such as a third switch K3 and a fourth switch K4 in the figure). The second switching unit is connected between an output end of the AC-DC conversion circuit 103 and the AC output interface 105, and is configured to control connection and disconnection between the AC-DC conversion circuit 103 and the AC output interface 105. When the energy storage apparatus 100 is in the second operating mode, in addition to controlling the AC-DC conversion circuit 103 to start with a delay, the control circuit may output the control signal to turn on the second switching unit upon expiration of the predetermined delay duration, enabling a power supply loop to be connected. Thus, a second implementation of delayed power supply is provided. That is, the AC-DC conversion circuit 103 may start operating immediately after the power outage, and the electric energy is output to the load only after an output switch (the second switching unit) of the AC-DC conversion circuit 103 is turned on.

The energy storage apparatus in the embodiments of the present disclosure realizes flexible configuration and intelligent switching of power supply modes through the above hardware architecture and control logic. Thus, not only can continuous power supply for critical loads be guaranteed, but also utilization of electric charge for non-urgent loads can be optimized, significantly improving practicability and economy of household energy storage.

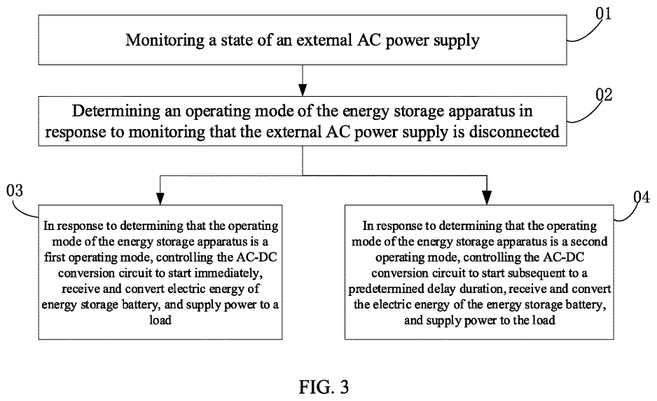

As illustrated in FIG. 3, based on the above energy storage apparatus 100, the present disclosure provides an output control method for the energy storage apparatus. The output control method includes: 01, monitoring a state of the external AC power supply; 02, determining an operating mode of the energy storage apparatus in response to monitoring that the external AC power supply is disconnected; 03, in response to determining that the operating mode of the energy storage apparatus is the first operating mode, controlling the AC-DC conversion circuit to start immediately, receive and convert electric energy of the energy storage battery, and supply power to the load; or 04, in response to determining that the operating mode of the energy storage apparatus is the second operating mode, controlling the AC-DC conversion circuit to start subsequent to the predetermined delay duration, receive and convert the electric energy of the energy storage battery, and supply power to the load.

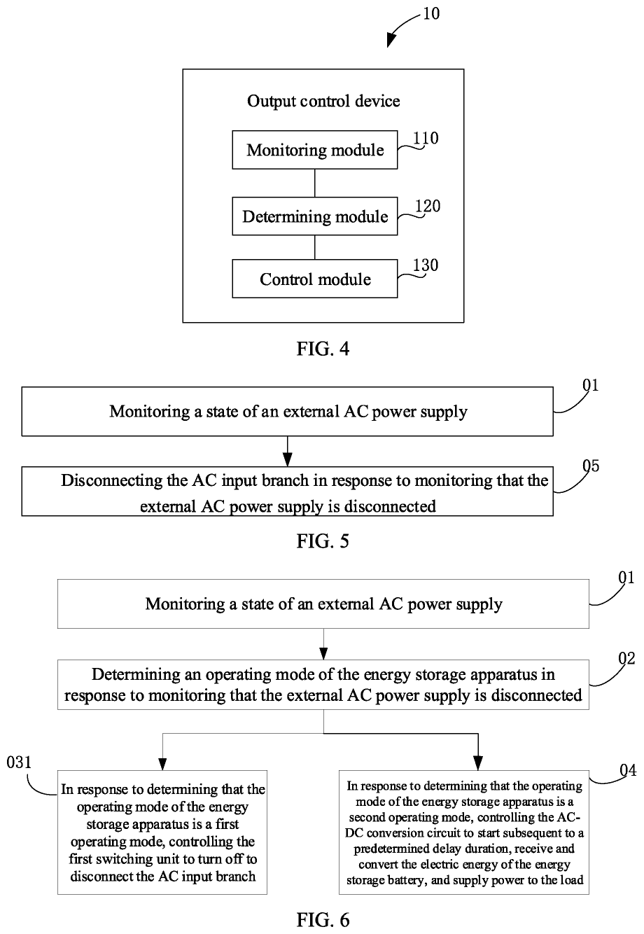

As illustrated in FIG. 4, the present disclosure further provides an output control device 10 of the energy storage apparatus. The output control device 10 includes a monitoring module 110, a determining module 120, and a control module 130. The above operation 01 may be implemented by the monitoring module 110, operation 02 may be implemented by the determining module 120, and the above operation 03 and operation 04 may be implemented by the control module 130.

In other words, the monitoring module 110 is configured to monitor the state of the external AC power supply. The determining module 120 is configured to determine the operating mode of the energy storage apparatus in response to monitoring that the external AC power supply is disconnected. The control module 130 is configured to control the AC-DC conversion circuit to start immediately, receive and convert the electric energy of the energy storage battery, and supply power to the load, in response to determining that the operating mode of the energy storage apparatus is the first operating mode; or control the AC-DC conversion circuit to start subsequent to the predetermined delay duration, receive and convert the electric energy of the energy storage battery, and supply power to the load, in response to determining that the operating mode of the energy storage apparatus is the second operating mode.

The present disclosure further provides an energy storage apparatus. The energy storage apparatus includes a memory and a processor. The memory has a computer-readable program stored thereon. The computer-readable program, when executed by the processor, causes the processor to implement the above output control method. That is, in response to determining that the operating mode of the energy storage apparatus is the first operating mode, the processor is configured to control the AC-DC conversion circuit to start immediately, receive and convert the electric energy of the energy storage battery, and supply power to the load; or in response to determining that the operating mode of the energy storage apparatus is the second operating mode, the processor is configured to control the AC-DC conversion circuit to start subsequent to the predetermined delay duration, receive and convert the electric energy of the energy storage battery, and supply power to the load.

In the output control method, the output control device 10, and the energy storage apparatus of the present disclosure, by differentially controlling the power supply to the load based on the set operating mode after the utility power is disconnected, immediate power supply to the non-urgent loads such as refrigerators can be effectively avoided, reducing unnecessary consumption of the energy storage electric charge, and significantly improving endurance of the energy storage apparatus during the power outage. Also, the method provides a selectable strategy of the first operating mode and the second operating mode, allowing a user to flexibly choose based on actual power consumption scenarios and needs, enhancing personalization and intelligence level of apparatus use.

The output control device 10 may exist in a hardware form or a software form. The output control device 10 may be an independent component independent of the energy storage apparatus 100. The output control device 10 may also be a part of a certain energy storage apparatus 100 and be integrated inside the energy storage apparatus 100 in the hardware form or the software form. In other words, the energy storage apparatus 100 includes the output control device 10. For example, when the output control device 10 serves as a part of the energy storage apparatus 100 and is integrated inside the energy storage apparatus 100, the output control device 10 may be integrated inside the processor.

The state of the external AC power supply may include a normal power supply state and a disconnection state (power outage state). The state of the external AC power supply may be determined by collecting electrical parameters such as a voltage and a frequency of the utility power grid in real time or periodically through a voltage sensor and a frequency detection circuit, and comparing these parameters with predetermined normal operating threshold ranges to determine whether the external AC power supply is in the normal power supply state or has experienced a disconnection (power outage) fault.

When the external AC power supply is monitored to be in the normal power supply state, that is, when the utility power is normally supplying power to the load, no operation is performed on the energy storage apparatus 100. When the external AC power supply is monitored to be disconnected (i.e., a power outage event occurs), an operating mode instruction predetermined by the user and stored in the energy storage apparatus 100 is immediately read, thus selecting the operating mode of the energy storage apparatus 100 in a power outage scenario.

The operating mode at least mainly includes the first operating mode and the second operating mode. The first operating mode may be an uninterruptible power supply (UPS) mode, and the second operating mode is a delay mode. The UPS mode refers to an operating mechanism by which the energy storage apparatus 100, when the external AC power supply is disconnected, achieves continuous power supply to the load, stable voltage/frequency regulation, and optimized electric energy quality through coordinated operation of core components such as a rectifier, an inverter, the energy storage battery 101 (such as a storage battery), and a static switch, ensuring continuity and reliability of the power supply to the load. The delay mode means that after the energy storage apparatus 100 receives a trigger signal, the energy storage apparatus 100 does not execute a corresponding operation immediately but instead delays a startup of an energy storage output function according to the predetermined delay duration, that is, the power supply is delayed.

It should be noted that the first operating mode is applicable to loads requiring continuous operation, such as a lighting apparatus, a network communication apparatus, an audio and video entertainment apparatus, etc. The second operating mode is applicable to loads only requiring periodic operation, such as a refrigerator, a water heater, an air conditioner, and other apparatuses with heat storage or cold storage capacity. In this way, a premature startup of the above apparatuses can be avoided, saving valuable energy storage electric charge.

Selection or switching of the operating mode can be configured through a human-machine interaction interface (such as a touch screen and keys) of the energy storage apparatus 100 or a matched mobile application program. For example, the energy storage apparatus 100 may be integrated with a Wi-Fi module and a Bluetooth module. The energy storage apparatus 100 may communicate with a mobile terminal through the Wi-Fi module and/or the Bluetooth module. When the energy storage apparatus 100 is powered on, the user may preset the operating mode of the energy storage apparatus 100 in a household power outage scenario through the mobile application program (APP) of the mobile terminal, or switch the current operating mode of the energy storage apparatus 100 in the household power outage scenario (for example, switching the operating mode of the energy storage apparatus 100 in the household power outage scenario from the first operating mode to the second operating mode).

It should be further noted that if the operating mode of the energy storage apparatus 100 selected in the power outage scenario is the second operating mode, the second operating mode will be automatically activated when the energy storage apparatus 100 is powered off and then powered on again. If the external AC power supply exists at this time, the utility power supplies power. If no external AC power supply exists, the energy storage apparatus 100 supplies power, and the second operating mode temporarily becomes invalid. That is, data in the APP settings will be cleared after the power outage.

When the user sets the operating mode of the energy storage apparatus 100 in the household power outage scenario as the second operating mode, the user may further define a specific delay duration corresponding to the second operating mode, in such a manner that after a delay duration following the power outage, the AC-DC conversion circuit 103 is controlled to start, receive and convert the electric energy of the energy storage battery, and supply power to the AC output interface 105. The delay duration may range from 1 minute to 24 hours, for example, the delay duration may be 1 minute, 2 minutes, 5 minutes, 10 minutes, 30 minutes, 1 hour, 2 hours, 2 hours and 30 minutes, 3 hours, 5 hours, 10 hours, 20 hours, etc., with no specific limitation. Further, the step unit for setting the delay duration is configured as follows: when the unit is hour (h), the step is 1 hour; and when the unit is minute (min), the step is 1 minute. In this way, the delay duration is facilitated to be precisely set by the user.

In response to identifying that the energy storage apparatus 100 is currently in the uninterruptible power supply (UPS) mode, an instruction is issued within a millisecond-level time period (usually less than 10 milliseconds) at the moment when the external AC power supply is disconnected, and the energy storage apparatus 100 is driven to switch an internal power switching device such as a static switch or a relay within T1 (T1≤10 ms), enabling the energy storage battery 101 of the energy storage apparatus 100 to be connected to the AC output interface 105 immediately through the AC-DC conversion circuit 103, thus achieving seamless and uninterruptible power supply for all loads or predetermined critical loads, and ensuring continuous operation of a power-interruption-sensitive apparatus such as a computer and a network apparatus.

In response to identifying that the energy storage apparatus 100 is currently in the second operating mode, an internal timer will be started. Within this predetermined delay duration (e.g., 30 minutes, 1 hour, etc., set by the user), the AC-DC conversion circuit 103 shall temporarily refrain from being connected to the AC output interface 105 for power supply. In this period, the system may maintain a low-power monitoring state. When the delay timing is completed, the power switching device is triggered to be connected to the energy storage battery 101 to supply power to the load. In this way, a problem of electric charge waste caused by the energy storage apparatus 100 immediately supplying power to the load after the power outage is avoided, saving the electric charge and extending the endurance of the energy storage apparatus 100.

In one embodiment, normal utility input supplies power to the load such as the refrigerator. The user opens a mobile terminal App, connects the energy storage apparatus 100 via Bluetooth/WiFi, selects the second operating mode on a setting interface, and sets the delay duration to 2 hours and 30 minutes. After the setting is completed, the energy storage apparatus 100 is still powered by the utility power instead of supplying power to the load. When the utility power is suddenly disconnected, the energy storage apparatus 100 activates the second operating mode and starts a countdown (2 hours and 30 minutes). In a countdown process, the refrigerator relies on its own sealed thermal insulation to maintain the temperature. Upon completion of the countdown, the AC-DC conversion circuit 103 automatically activates discharge to supply power to the refrigerator.

In another embodiment, the user has set the operating mode of the energy storage apparatus 100 in the power outage scenario to the second operating mode (with the delay duration of 3 hours). When the user needs to supply power to loads requiring high power supply continuity (e.g. the computer), the user selects and sets the first operating mode in the App. At this time, the second operating mode preset in the energy storage apparatus 100 is automatically deactivated. When the utility power is disconnected, the energy storage apparatus 100 continuously supplies power to the load within T1 (T1≤10 ms).

As illustrated in FIG. 5, in some embodiments, the output control method further includes: 05, disconnecting the AC input branch in response to monitoring that the external AC power supply is disconnected.

In some embodiments, operation 05 may be implemented by the control module 130. In other words, the control module 130 may be configured to disconnect the AC input branch in response to monitoring that the external AC power supply is disconnected.

In some embodiments, the processor may further be configured to disconnect the AC input branch in response to monitoring that the external AC power supply is disconnected.

Specifically, as illustrated in FIG. 1 and FIG. 2, the AC input branch 102 is connected between an external input interface and the AC output interface 105, and is configured to establish and cut off electrical connection between the external AC power supply and the AC output interface 105. When the AC input branch 102 is closed, the external AC power supply is connected to the AC output interface 105 through the AC input branch 102 to supply power to a load at the AC output interface 105. The AC input branch is disconnected in response to monitoring that the external AC power supply is disconnected.

In this way, the AC input branch is disconnected in response to monitoring that the external AC power supply is disconnected, in such a manner that physical disconnection between the AC input interface 104 and the AC output interface 105 is achieved, and dual safeguard for safe isolation and state reset is achieved.

As illustrated in FIG. 6, in some embodiments, operation 03 includes: controlling the first switching unit to turn off to disconnect the AC input branch.

In some embodiments, sub-operation 031 may be implemented by the control module 130. In other words, the control module 130 may be configured to control the first switching unit to turn off to disconnect the AC input branch.

In some embodiments, the processor may further be configured to control the first switching unit to turn off to disconnect the AC input branch.

The first switching unit is disposed on the AC input branch 102 and configured to achieve connection and disconnection of the AC input branch 102. When the first switching unit is turned on, the AC input branch 102 is connected. When the first switching unit is turned off, the AC input branch 102 is disconnected. The AC-DC conversion circuit 103 is connected to the AC output interface 105 via the second switching unit. When the second switching unit is turned on, the AC-DC conversion circuit 103 is connected to the AC output interface 105.

The first switching unit includes the first switch K1 and the second switch K2. The second switching unit may include the third switch K3 and the fourth switch K4. The energy storage apparatus 100 may further include a power switching device. The power switching device may be electrically connected to the first switch K1, the second switch K2, the third switch K3, and the fourth switch K4, and is configured to control turning on and turning off of the first switch K1, the second switch K2, the third switch K3, and the fourth switch K4.

In response to determining that the energy storage apparatus 100 enters the first operating mode, a precise timing control instruction may be transmitted to the power switching device. The instruction drives the power switching device to turn off the first switch K1 and the second switch K2 (as illustrated in FIG. 3), in such a manner that the AC input branch 102 is disconnected, a load side is electrically isolated from the power grid suffering the power outage, operational safety is guaranteed, and reverse power transmission is prevented. Immediately afterwards, a second instruction is transmitted within a predetermined extremely short delay (typically less than 10 milliseconds to achieve an uninterruptible power supply effect). The power switching device controls the third switch K3 and the fourth switch K4 to turn on, in such a manner that energy of the energy storage battery 101 is converted by the AC-DC conversion circuit 103 and instantaneously connected to a load terminal, thus stably and reliably undertaking a power supply task of all loads.

In this way, by controlling the first switching unit to turn off to disconnect the AC input branch and controlling the second switching unit to turn on to connect an output path of the AC-DC conversion circuit 103, rapid, reliable and electrically isolated switching of the power supply path is achieved. At the moment when the external AC power supply is disconnected, the system can simultaneously complete two key actions including power grid isolation and energy storage power supply connection. Not only is the power supply continuity of sensitive loads such as computers and network apparatuses ensured, effectively preventing data loss or operation interruption; but also, through timing control of disconnection before connection, a circulating current or conflict that may occur between the utility power and an inverter output is completely avoided, improving overall operational safety and apparatus reliability of the system, which is a core guarantee for achieving millisecond-level uninterruptible switching (UPS function).

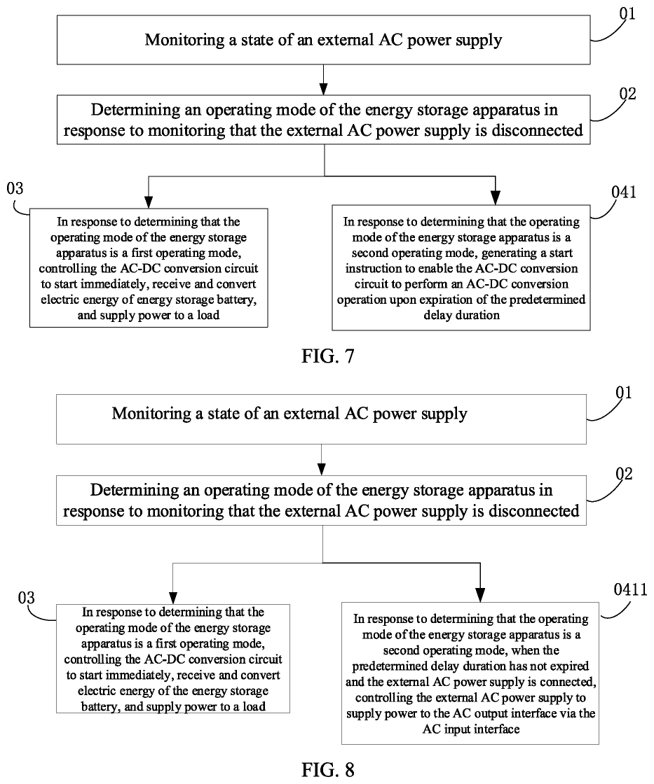

As illustrated in FIG. 7, in some embodiments, operation 04 includes: 041, generating a start instruction to enable the AC-DC conversion circuit to perform an AC-DC conversion operation upon expiration of the predetermined delay duration.

In some embodiments, sub-operation 041 may be implemented by the control module 130. In other words, the control module 130 may be configured to generate the start instruction to enable the AC-DC conversion circuit to perform the AC-DC conversion operation upon expiration of the predetermined delay duration.

In some embodiments, the processor may be configured to generate the start instruction to enable the AC-DC conversion circuit to perform the AC-DC conversion operation upon expiration of the predetermined delay duration.

In this way, the start instruction is generated to enable the AC-DC conversion circuit 103 to start operating upon expiration of the predetermined delay duration. During a delay waiting period, the AC-DC conversion circuit 103 is entirely in a sleep or standby state, and only necessary control circuits are maintained for low-power operation. As a result, self-energy consumption of the system is reduced to the greatest extent, electric charge waste caused by supplying power to the non-urgent loads at an initial stage of the power outage is avoided, overall energy efficiency of the energy storage apparatus is significantly optimized, and a sustainable power supply duration of the energy storage apparatus under emergency conditions is extended.

As illustrated in FIG. 8, in some embodiments, operation 041 includes: 0411, when the predetermined delay duration has not expired and the external AC power supply is connected, controlling the external AC power supply to supply power to the AC output interface via the AC input interface.

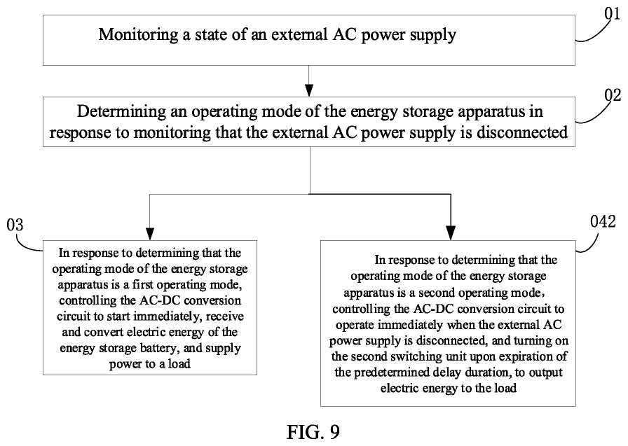

As illustrated in FIG. 9, in some embodiments, operation 04 includes: 042, controlling the AC-DC conversion circuit to operate immediately when the external AC power supply is disconnected, and turning on the second switching unit upon expiration of the predetermined delay duration, to output electric energy to the load.

In some embodiments, sub-operation 042 may be implemented by the control module 130. In other words, the control module 130 may be configured to control the AC-DC conversion circuit to operate immediately when the external AC power supply is disconnected, and turn on the second switching unit upon expiration of the predetermined delay duration, to output the electric energy to the load.

In some embodiments, the processor may further be configured to control the AC-DC conversion circuit to operate immediately when the external AC power supply is disconnected, and turn on the second switching unit upon expiration of the predetermined delay duration, to output the electric energy to the load.

Specifically, a circuit switching device may be controlled to turn off the first switch K1 and the second switch K2 of the AC input branch 102. Also, a current sensor or a load detection circuit is used to monitor in real-time whether the current is output from an output end of the energy storage battery 101 (i.e., whether the energy storage apparatus 100 is supplying power to the load). In response to monitoring that the energy storage apparatus 100 is not supplying power currently, a waiting state is entered and an internal timer is activated. Upon expiration of the predetermined delay duration, an instruction is transmitted to turn on the third switch K3 and the fourth switch K4 of the AC-DC conversion circuit 103 to start the power supply. In response to monitoring that the energy storage apparatus is already supplying power (for example, during switching from another mode), the AC-DC conversion circuit 103 is actively disconnected first (i.e., the third switch K3 and the fourth switch K4 are disconnected) to stop the power supply. The timer is then activated in the same way. Upon expiration of the same predetermined delay duration, the third switch K3 and the fourth switch K4 in the AC-DC conversion circuit 103 are turned on again to restore the power supply.

In one embodiment, in response to monitoring that the external AC power supply exists, the first switch K1, the second switch K2, the third switch K3, and the fourth switch K4 are turned on (as illustrated in FIG. 4), and the AC input branch 102 supplies power to the load. After the second operating mode is successfully set, the first switch K1, the second switch K2, the third switch K3, and the fourth switch K4 are still turned on, that is, the AC input branch 102 supplies power to the load. When a utility power outage is monitored, the first switch K1, the second switch K2, the third switch K3, and the fourth switch K4 are immediately turned off, and a countdown is started. Upon completion of the countdown, the third switch K3 and the fourth switch K4 are turned on again (as illustrated in FIG. 3), in such a manner that the energy storage battery 101 supplies power to the load via the AC-DC conversion circuit 103.

In this way, the AC-DC conversion circuit 103 is controlled to operate immediately when the external AC power supply is disconnected, and upon expiration of the predetermined delay duration, the second switching unit is turned on to output the electric energy. The AC-DC conversion circuit 103 is started in advance and enters a stable operating state, but power supply delay is realized by controlling the second switching unit at an output end of the AC-DC conversion circuit 103. Upon expiration of the delay duration, the power supply can be performed instantly by turning on merely one switch. In this way, a higher response speed is achieved, and delay in a process where the conversion circuit transitions from startup to stable output is avoided. Meanwhile, this method also prevents electrical stress and loss potentially caused by frequent startup and shutdown of the AC-DC conversion circuit 103 during a delay period, and is facilitated to improve long-term reliability of a power element.

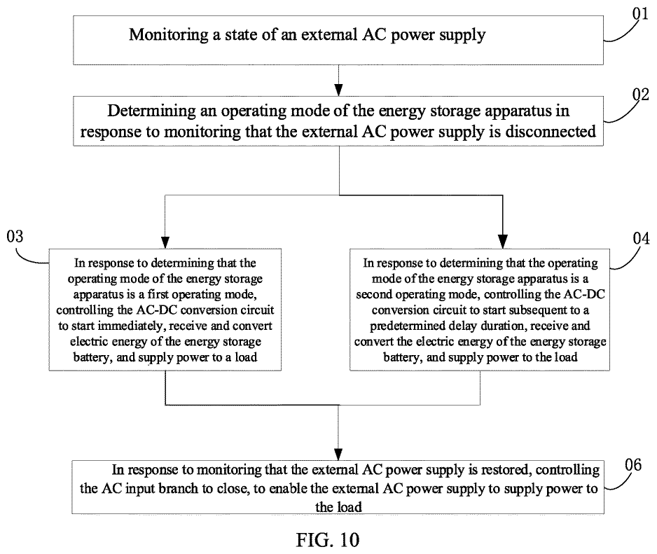

As illustrated in FIG. 10, in some embodiments, the output control method further includes: 06, in response to monitoring that the external AC power supply is restored, controlling the AC input branch to close, to enable the external AC power supply to supply power to the load.

In some embodiments, operation 06 may be implemented by the control module 130. In other words, the control module 130 may be configured to, in response to monitoring that the external AC power supply is restored, control the AC input branch to close, to enable the external AC power supply to supply power to the load.

In some embodiments, the processor may further be configured to, in response to monitoring that the external AC power supply is restored, control the AC input branch to close, to enable the external AC power supply to supply power to the load.

Specifically, during recovery of the utility power, a continuously operating voltage sensor and the frequency detection circuit in the energy storage apparatus 100 may detect that whether a grid voltage and a frequency parameter have stably returned to normal ranges, and determine that this state lasts for a set debounce time (such as several seconds) to avoid misjudgment. If it is determined that the utility power has been restored, the energy storage apparatus 100 may stop supplying power to the load. Subsequent to determining that the energy storage apparatus 100 has stopped supplying power to the load, an instruction is transmitted to the first switch K1 and the second switch K2 in the AC input branch 102 to control the first switch K1 and the second switch K2 to turn on (at this time, the third switch K3 and the fourth switch K4 are already turned on), and the load is reconnected to the utility power grid.

In this way, by switching a power source of the load from an energy storage inverter output back to the utility power grid when the utility power is restored, safe and stable conversion of a main power supply circuit is achieved, improving convenience and the intelligence level of use. In addition, by first disconnecting the inverter output and then closing the AC input branch 102, it is ensured that no circulating current or conflict is generated between the power grid and the energy storage inverter at the moment of switching, effectively protecting a power electronic apparatus from potential damage.

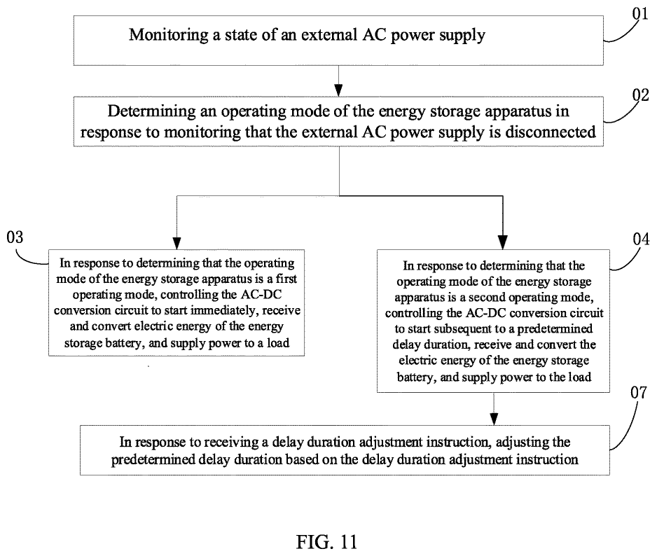

As illustrated in FIG. 11, in some embodiments, the output control method further includes: 07, in response to receiving a delay duration adjustment instruction, adjusting the predetermined delay duration based on the delay duration adjustment instruction.

In some embodiments, operation 07 may be implemented by the control module 130. In other words, the control module 130 may further be configured to, in response to receiving the delay duration adjustment instruction, adjust the predetermined delay duration based on the delay duration adjustment instruction.

In some embodiments, the processor may further be configured to, in response to receiving the delay duration adjustment instruction, adjust the predetermined delay duration based on the delay duration adjustment instruction.

It should be noted that the user may transmit a delay duration adjustment instruction containing a specific time parameter (such as minutes or hours) via a local human-machine interaction interface of the apparatus (e.g., a touch screen or physical keys) or a remotely connected mobile application. Upon the control module or the processor receiving the instruction, the control module or the processor first verifies validity of the instruction (for example, by determining whether the value falls within an allowable range). A new time value is then updated and stored in a non-volatile memory.

When the power outage occurs, and the energy storage apparatus 100 is executing the second operating mode and performing countdown based on the predetermined delay duration, the new time value is directly used as the delay duration, and the countdown is restarted with the new delay duration. When the AC input branch 102 is currently supplying power to the load, the new time value will be set as a new standard for the predetermined delay duration when the second operating mode is executed subsequently. Afterwards, when the system enters the second operating mode again, the timer of the system will directly adopt the updated duration parameter for delay waiting, to achieve dynamic and personalized configuration of a power supply strategy.

For example, when no utility power is available, the energy storage apparatus 100 is powered on and operates in the second operating mode, with a countdown (of 1 hour and 10 minutes) initiated. During the countdown (for example, 30 minutes remaining), the user connects to the energy storage apparatus App via the Bluetooth/Wi-Fi and sets a new delay duration of 2 hours. After the setting is completed, the timer directly adopts the new delay duration of 2 hours to restart the countdown. Upon completion of the countdown, the energy storage apparatus 100 discharges power through the AC-DC conversion circuit 103.

Thus, by introducing an adjustable delay duration mechanism, the user can flexibly set a specific waiting time for delayed power supply based on actual power demands, load characteristics, or specific scenarios. Personalization and adaptability of output control of the energy storage apparatus 100 is significantly enhanced, enabling the user to perform refined management in view of thermal insulation performance of different loads (e.g., refrigerators) in various seasons or specific power consumption plans. Thus, on the premise of ensuring basic power consumption demands, a distribution strategy of the energy storage electric charge is further optimized to prolong the power supply duration for the critical loads to the greatest extent.

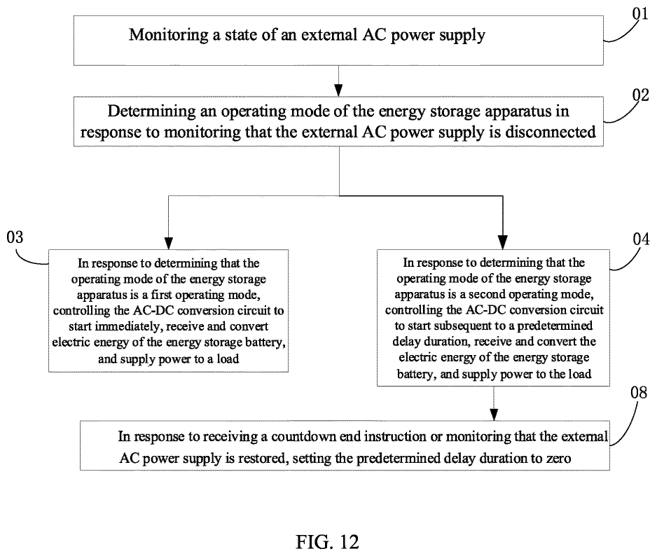

As illustrated in FIG. 12, in some embodiments, the output control method further includes: 08, in response to receiving a countdown end instruction or monitoring that the external AC power supply is restored, setting the predetermined delay duration to zero.

In some embodiments, operation 08 may be implemented by the control module 130. In other words, the control module 130 may further be configured to, in response to receiving the countdown end instruction or monitoring that the external AC power supply is restored, set the predetermined delay duration to zero.

In some embodiments, the processor may further be configured to, in response to receiving the countdown end instruction or monitoring that the external AC power supply is restored, set the predetermined delay duration to zero.

Specifically, when the energy storage apparatus 100 operates in the second operating mode during the power outage, the internal timer performs the countdown based on the predetermined delay duration. If a countdown end instruction actively transmitted by the user is received via a human-machine interaction interface or a communication module, or a built-in monitoring circuit continuously detects that a voltage parameter and a frequency parameter of the external AC power supply have stably returned to the normal ranges, the predetermined delay duration is set to zero, causing the timer to stop counting down and the energy storage apparatus 100 to exit the waiting state. Thus, the AC-DC conversion circuit 103 is immediately controlled to close to supply power to the load, or, when the utility power is restored, rapid switching back to a utility power supply is performed.

In this way, by introducing a dynamic zeroing mechanism for the delay duration, real-time response capability of the energy storage apparatus 100 to external changes and user intentions is significantly improved. When the user actively transmits an instruction to immediately end the waiting, or when the system detects that the utility power has been restored, this mechanism can forcibly set the remaining delay duration to zero, thus instantly triggering subsequent power supply or power switching actions. Thus, the user may take the initiative to cancel the delay and obtain power immediately under emergency or special conditions, enhancing control flexibility. Also, when the utility power is restored, the system can immediately terminate unnecessary discharge delays and automatically switch to a better grid power supply mode, achieving intelligent protection of the energy storage electric charge and further optimization of overall energy efficiency.

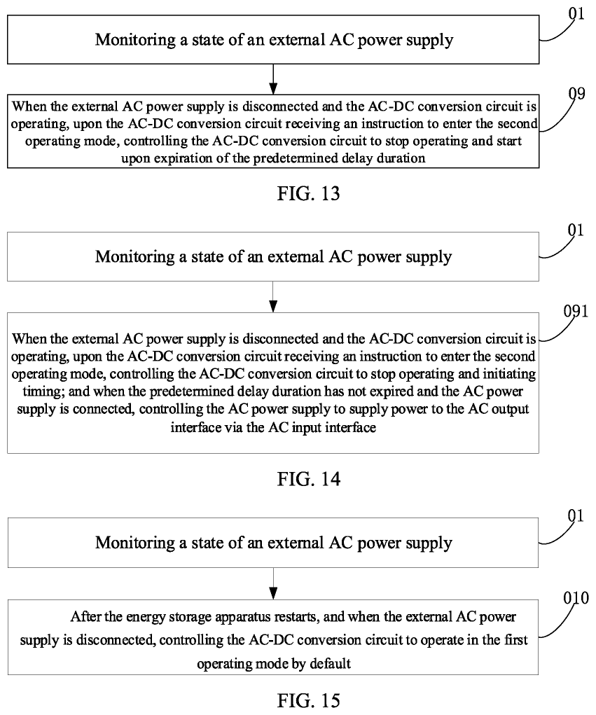

As illustrated in FIG. 13, in some embodiments, the output control method further includes: 09, when the external AC power supply is disconnected and the AC-DC conversion circuit is operating, upon the AC-DC conversion circuit receiving an instruction to enter the second operating mode, controlling the AC-DC conversion circuit to stop operating and start upon expiration of the predetermined delay duration.

As illustrated in FIG. 14, in some embodiments, operation 09 includes: 091, when the external AC power supply is disconnected and the AC-DC conversion circuit is operating, upon the AC-DC conversion circuit receiving the instruction to enter the second operating mode, controlling the AC-DC conversion circuit to stop operating and initiating timing; and when the predetermined delay duration has not expired and the AC power supply is connected, controlling the AC power supply to supply power to the AC output interface via the AC input interface.

As illustrated in FIG. 15, in some embodiments, the output control method further includes: 010, after the energy storage apparatus restarts, and when the external AC power supply is disconnected, the AC-DC conversion circuit operates in the first operating mode by default.

The above embodiments illustrate merely some implementations of the present disclosure, which are described in details but are not construed to limit the scope of the present disclosure. It should be pointed that, for those skilled in the art, without departing from the principle of the present disclosure, various changes and improvements may be made, which are covered by the protection scope of the present disclosure. Therefore, the protection scope of the present disclosure is according to the appended claims.

What is claimed is:

1. An energy storage apparatus, comprising:
an alternating-current (AC) input interface configured to receive an external AC power supply;
an AC output interface connected to the AC input interface and configured to output alternating current externally;
an energy storage battery configured to store and output electric energy; and
an AC-direct current (DC) conversion circuit having an end connected to the energy storage battery and the other end connected to the AC output interface,
wherein the energy storage apparatus has a first operating mode and a second operating mode when the AC power supply is disconnected, wherein:
in the first operating mode, the AC-DC conversion circuit is configured to start immediately, receive and convert the electric energy of the energy storage battery, and supply power to the AC output interface; and
in the second operating mode, the AC-DC conversion circuit is configured to start subsequent to a predetermined delay duration, receive and convert the electric energy of the energy storage battery, and supply power to the AC output interface.

2. The energy storage apparatus according to claim 1, further comprising an AC input branch, wherein:
the AC input interface is connected to the AC-DC conversion circuit and the AC output interface via the AC input branch; and
the AC input branch comprises a first switching unit configured to control connection and disconnection of the AC input branch, wherein the first switching unit is turned off when the AC power supply is disconnected.

3. The energy storage apparatus according to claim 1, further comprising a control circuit, wherein:
the control circuit is configured to, when the energy storage apparatus is in the second operating mode and the AC power supply is disconnected, initiate timing, and control the AC-DC conversion circuit to start upon expiration of the predetermined delay duration.

4. The energy storage apparatus according to claim 3, wherein when the timing of the control circuit has not ended and the AC power supply is connected, the AC power supply is configured to supply power to the AC output interface via the AC input interface.

5. The energy storage apparatus according to claim 1, wherein when the AC power supply is disconnected and the AC-DC conversion circuit is operating, upon the AC-DC conversion circuit receiving an instruction to enter the second operating mode, the AC-DC conversion circuit stops operating and starts upon expiration of the predetermined delay duration.

6. The energy storage apparatus according to claim 5, wherein the AC power supply is configured to, when the predetermined delay duration has not expired and the AC power supply is connected, supply power to the AC output interface via the AC input interface.

7. The energy storage apparatus according to claim 1, wherein the AC power supply is configured to, when the energy storage apparatus is in the first operating mode or the second operating mode and the AC power supply is connected, supply power to the AC output interface via the AC input interface.

8. The energy storage apparatus according to claim 1, wherein after the energy storage apparatus restarts, and when AC power supply is disconnected, the AC-DC conversion circuit operates in the first operating mode by default.

9. The energy storage apparatus according to claim 1, further comprising a second switching unit, wherein:
the second switching unit is connected between the AC-DC conversion circuit and the AC output interface, and is configured to control connection and disconnection between the AC-DC conversion circuit and the AC output interface; and
when the energy storage apparatus is in the second operating mode, timing is initiated, and the second switching unit is controlled to turn on upon expiration of the predetermined delay duration, to connect the AC-DC conversion circuit to the AC output interface.

10. An output control method for an energy storage apparatus, the energy storage apparatus comprising an energy storage battery and an AC-DC conversion circuit, and the output control method comprising:
monitoring a state of an external AC power supply;
determining an operating mode of the energy storage apparatus in response to monitoring that the external AC power supply is disconnected;
in response to determining that the operating mode of the energy storage apparatus is a first operating mode, controlling the AC-DC conversion circuit to start immediately, receive and convert electric energy of the energy storage battery, and supply power to a load; or
in response to determining that the operating mode of the energy storage apparatus is a second operating mode, controlling the AC-DC conversion circuit to start subsequent to a predetermined delay duration, receive and convert the electric energy of the energy storage battery, and supply power to the load.

11. The output control method according to claim 10, wherein:
the energy storage apparatus further comprises an AC input branch; and
the output control method further comprises: disconnecting the AC input branch in response to monitoring that the external AC power supply is disconnected.

12. The output control method according to claim 11, wherein the energy storage apparatus further comprises a first switching unit arranged in the AC input branch and a second switching unit connected to an output end of the AC-DC conversion circuit, wherein said controlling the AC-DC conversion circuit to start immediately comprises:
controlling the first switching unit to turn off to disconnect the AC input branch.

13. The output control method according to claim 10, wherein said in response to determining that the operating mode of the energy storage apparatus is the second operating mode, controlling the AC-DC conversion circuit to start subsequent to the predetermined delay duration comprises:
generating a start instruction to enable the AC-DC conversion circuit to perform an AC-DC conversion operation upon expiration of the predetermined delay duration.

14. The output control method according to claim 13, wherein said controlling the AC-DC conversion circuit to start subsequent to the predetermined delay duration comprises:
when the predetermined delay duration has not expired and the external AC power supply is connected, controlling the external AC power supply to supply power to the AC output interface via the AC input interface.

15. The output control method according to claim 10, further comprising:
when the external AC power supply is disconnected and the AC-DC conversion circuit is operating, upon the AC-DC conversion circuit receiving an instruction to enter the second operating mode, controlling the AC-DC conversion circuit to stop operating and start upon expiration of the predetermined delay duration,
or after the energy storage apparatus restarts, and when the external AC power supply is disconnected, controlling the AC-DC conversion circuit to operate in the first operating mode by default.

16. The output control method according to claim 10, wherein the energy storage apparatus further comprises a second switching unit connected to an output end of the AC-DC conversion circuit, wherein said in response to determining that the operating mode of the energy storage apparatus is the second operating mode, controlling the AC-DC conversion circuit to start subsequent to the predetermined delay duration comprises:
controlling the AC-DC conversion circuit to operate immediately when the external AC power supply is disconnected, and turning on the second switching unit upon expiration of the predetermined delay duration, to output electric energy to the load.

17. The output control method according to claim 13, further comprising:
in response to receiving a delay duration adjustment instruction, adjusting the predetermined delay duration based on the delay duration adjustment instruction.

18. The output control method according to claim 13, further comprising:
in response to receiving a countdown end instruction or monitoring that the external AC power supply is restored, setting the predetermined delay duration to zero.

19. The output control method according to claim 11, further comprising:
in response to monitoring that the external AC power supply is restored, controlling the AC input branch to close, to enable the external AC power supply to supply power to the load.

20. An output control device of an energy storage apparatus, comprising:
a processor; and
a memory having a computer program stored thereon,
wherein the computer program, when executed by the processor, causes the processor to implement the following operations:
monitoring a state of an external AC power supply;
determining an operating mode of the energy storage apparatus in response to monitoring that the external AC power supply is disconnected;
in response to determining that the operating mode of the energy storage apparatus is a first operating mode, controlling an AC-DC conversion circuit in the energy storage apparatus to start immediately, to convert electric energy of the energy storage battery into alternating current and supply power to a load; or
in response to determining that the operating mode of the energy storage apparatus is a second operating mode, controlling the AC-DC conversion circuit to start subsequent to a predetermined delay duration, to convert the electric energy of the energy storage battery into the alternating current and supply power to the load.
